(19) United States
(12) Patent Application Publication
(10) Pub. No.: US 2007/0064851 A1
(43) Pub. Date: Mar. 22, 2007

(54) Method for synchronizing a customer edge router or customer premise equipment associated therewith

(75) Inventor: Andrew Jeffrey Hall II, Round Rock, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/219,502

(22) Filed: Sep. 2, 2005

(51) Int. Cl. H04L 7/00

(52) U.S. Cl. 375/356

(57) ABSTRACT

A PE router (106) coupled to a timing source (206) has a routing element (202), and a controller (204). The controller is programmed to establish (306) a synchronization cycle with a CE router, and supply (310, 312) the CE router synchronization information derived from the timing source for synchronizing the CE router and customer premise equipment (CPE) coupled thereto.

### FIELD OF THE DISCLOSURE

The present disclosure relates generally to synchronization methods, and more specifically to a method for synchronizing a customer edge (CE) router or customer premise equipment (CPE) associated therewith.

### BACKGROUND

Currently service providers transport voice, video and other time sensitive services using a BITS synchronized time division multiplexed (TDM) network that assures the timing characteristics of the original signal are maintained across the network. The timing requirements for the TDM networks are set forth in, for example, Telcordia® requirements such as GR-2820-CORE, GR-1244-CORE and GR-253-CORE. By implementing the capabilities specified in these requirements and using the framed structure of the signals used in TDM networks, service providers are able to precisely time Carrier Equipment (CE) at the customer's premises using a capability called line timing.

Line timing, however, cannot be used to provide precision timing to a CE in a packet-based network using Ethernet interfaces because these interfaces are asynchronous. Such interfaces frequently encounter synchronization issues such as latency, slippage, wander or jitter, which results in lost or corrupt packets. In end-to-end communications, packet losses are remedied by retransmissions, which can interfere with real-time services such as VoIP (Voice over IP), and/or video.

If time sensitive services are to be supported on packet-based networks with the same quality of service found in TDM networks a method must be found to distribute timing to the all networks elements including customer premise equipment.

### BRIEF DESCRIPTION OF THE DRAWINGS

FIG. 1 is a block diagram of a communication network incorporating teachings of the present disclosure;

FIG. 2 is a block diagram of router components incorporating teachings of the present disclosure;

FIG. 3 depicts a flowchart of a method operating in a provider edge router incorporating teachings of the present disclosure;

FIG. 4 depicts a flowchart of a method operating in one among a customer edge router and customer premise equipment incorporating teachings of the present disclosure; and

FIG. 5 is a diagrammatic representation of a machine in the form of a computer system within which a set of instructions, when executed, may cause the machine to perform any one or more of the methodologies discussed herein.

### DETAILED DESCRIPTION OF THE DRAWINGS

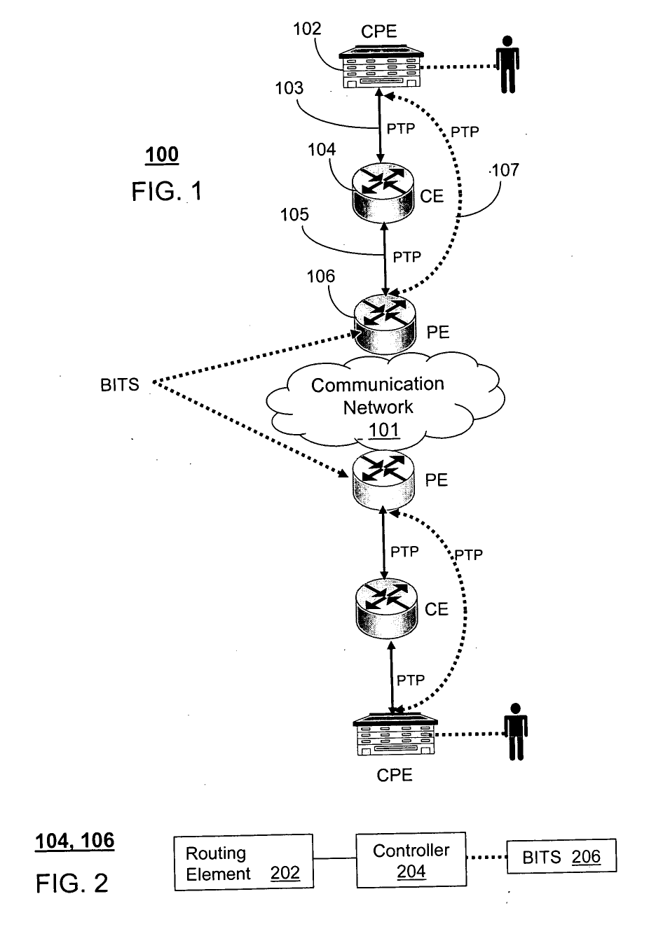

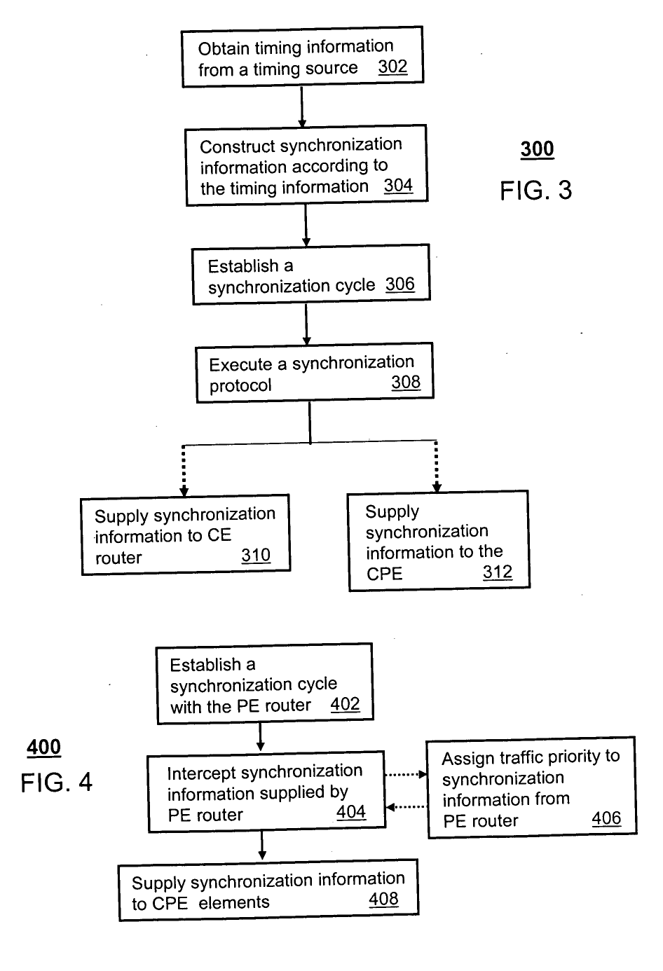

FIG. 1 is a block diagram of a communication network 100 incorporating teachings of the present disclosure. The communication network 100 comprises a packet network 101 such as, for example, a conventional IP (Internet Protocol) network, or a conventional MPLS (Multi-Protocol Label Switching) network. The communication network 100 utilizes conventional provider edge (PE) routers 106 to couple the network 101 to customer edge (CE) routers 104 that manage communications with customer premise equipment (CPE) 102.

FIG. 2 is a block diagram of router components incorporating teachings of the present disclosure. According to FIG. 2, each of the aforementioned CE and PE routers 104 and 106 comprise a conventional routing element 202 and controller 204. The routing element 202 is managed by the controller 204 to supply conventional communication services that comply with IP or MPLS protocols, thereby providing customers coupled to the CPE end-to-end communication services such as VoIP (Voice over IP), data communications, video on demand, and so on, by way of network 101.

A PE router 106 can further include a timing source comprising a conventional Building Integrated Timing Supply (BITS) that complies with, for example, clock requirements set forth in GR-1244-CORE. The BITS 206 can be in the same proximity as the PE router 106 in question, or remotely derived from another element of the communication network 101. Alternatively, the PE router 106 can utilize a Global Position System (GPS) reference as a timing source so long as elements of the communication network 101 are synchronized to the same source.

It would be apparent to those with ordinary skill in the art that the PE router 106 can utilize any conventional timing source that the communication network 101 utilizes for synchronization purposes. Additionally, said timing source can be an integral part of the PE router 106, co-located therewith, or distributed in the communication network 101 in which the routing element 202, managed by the controller 204, can extract timing from the network 101 according to conventional means well-known in the art. The timing precision of the PE router 106 can be stratum 3 or better depending on its synchronization capabilities and its source for synchronization.

The timing of the PE router 106 can be used to synchronize the CE router 104 and/or the CPE 102 by way of a method 300 depicted in FIG. 2 operating therein according to teachings of the present disclosure. Method 300 begins with step 302 where the PE router 106 extracts timing information from the timing source as described above. In step 304, synchronization information is constructed according to the timing information supplied by step 302. The PE router 106 is then programmed in step 306 to establish a synchronization cycle with either of the CE router 104 or the CPE 102. The synchronization cycle can be periodic or asynchronous. That is, the synchronization cycle can be timed so that it occurs at predetermined intervals according to an estimated out-of-synchronization cycle, i.e., an expected time when an interface 105 between the CE and PE routers is expected to fall out of synchronization. Alternatively, the synchronization cycle can be asynchronous such that the PE router 106 monitors by conventional means timing from the CE router 106 and invokes a synchronization cycle when appropriate.

Once the synchronization cycle has been established, in step 308 the PE router 106 executes a synchronization protocol. The synchronization protocol can comprise one among a group of conventional synchronization protocols such as a Precision Time Protocol (PTP), a Network Timing Protocol (NTP), and a Real-Time Protocol (RTP). The routing element of the PE router 202 can, for example, utilize conventional hardware-assisted techniques to deliver nanosecond-precise synchronization to the CE router 104 based on IEEE's 1588 PTP standard. Assuming in the present illustration that PTP is used between interfaces 103 and 105, the PE router 106 can in steps 310 or 312 supply synchronization information to the CE router 104 or the CPE 102 (if it is capable of establishing a PTP session with the PE router). Each of these recipients can then synchronize themselves with the communication network 101 according to steps defined in IEEE 1588, thereby eliminating synchronization outages caused by jitter and/or wander.

FIG. 4 depicts a flowchart of a method 400 operating in one among the CE router 104 and CPE 102 incorporating teachings of the present disclosure. Method 400 illustrates the operations in the CE router 104 and/or CPE 102 for synchronizing with the PE router 106. For illustration only, method 400 focuses on the CE router 104. This description, however, is also applicable to the CPE 102. Similar to method 300 described above, method 400 begins with step 402 where the CE router 104 establishes a synchronization cycle with the PE router 106. In step 404, the CE router 104 intercepts synchronization information from the PE router 106 according to any one of the aforementioned synchronization protocols.

To avoid an interruption that can disrupt the synchronization cycle, the CE router 106 can be programmed in step 406 to assign traffic priority to the synchronization information exchanged with the PE router 106. This assignment helps to minimize a possibility that conventional packet traffic will interrupt precision timing packets exchanged between the PE router 106 and the CE router 104. In step 408, the CE router 104 supplies the synchronization information to elements of the CPE 102. Each of the CE router 104 and elements of the CPE 102 utilize this information for synchronization to network 101. In an embodiment in which the CPE 102 performs the functions of method 400, step 408 can represent distribution of synchronization information to the CE router 104, and communication elements (e.g., an access point) of the CPE commonly operating in an enterprise network.

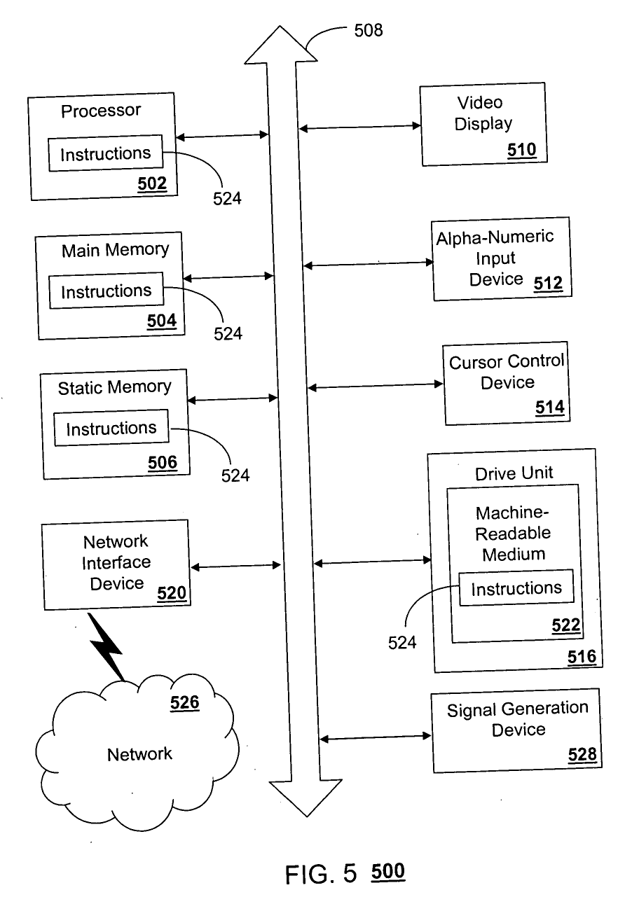

FIG. 5 is a diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. For example, modifying step 208 so that it directs callers to either step 219 and/or steps 216 through 222 is an alteration to method 200 that is inclusive of the scope and spirit of the claims described below. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A PE router, comprising:
a routing element; and
a controller programmed to:
establish a synchronization cycle with one among a CE router and customer premise equipment (CPE); and
supply the CE router or CPE synchronization information derived from a timing source for synchronizing said CE router and CPE coupled thereto.

2. The PE router of claim 1, wherein the synchronization information comprises a plurality of packets transporting timing information, and wherein the controller is programmed to assign traffic priority to said plurality of packets.

3. The PE router of claim 1, wherein the timing source comprises a Building Integrated Timing Supply (BITS), and wherein the controller is programmed to:
construct the synchronization information according to timing information extracted from the BITS; and
supply the synchronization information to the CE router according to a synchronization protocol.

4. The PE router of claim 3, wherein the controller is programmed to execute the synchronization protocol according to one among a group of synchronization protocols comprising a Precision Time Protocol (PTP), a Network Timing Protocol (NTP), and a Real-Time Protocol (RTP).

5. The PE router of claim 1, wherein the CE router synchronizes the CPE according to the synchronization information.

6. The PE router of claim 1, wherein the CPE synchronizes the CE router according to the synchronization information.

7. The PE router of claim 1, wherein the timing source comprises a Global Position System (GPS) reference.

8. In a PE router, a computer-readable storage medium comprising computer instructions for:
obtaining synchronization information from a timing source;
establishing a periodic synchronization cycle with a CE router; and
supplying the CE router synchronization information for synchronizing the CE router and customer premise equipment (CPE) associated with the CE router.

9. The storage medium of claim 8, wherein the synchronization information comprises a plurality of packets transporting timing information, and wherein the storage medium comprises computer instructions for assigning traffic priority to said plurality of packets.

10. The storage medium of claim 8, wherein the timing source comprises a Building Integrated Timing Supply (BITS), and wherein the storage medium comprises computer instructions for executing a synchronization protocol according to one among a Precision Time Protocol (PTP), a Network Timing Protocol (NTP), and a Real-Time Protocol (RTP).

11. A CE router, comprising:
a routing element; and
a controller programmed to:
establish a synchronization cycle with a PE router;
intercept synchronization information from the PE router;
synchronize the routing element; and
supply the synchronization information to customer premise equipment (CPE) by way of the routing element.

12. The CE router of claim 11, wherein the controller is programmed to execute a synchronization protocol to exchange synchronization information with the PE router.

13. The CE router of claim 12, wherein the synchronization protocol comprises one among a Precision Time Protocol (PTP), a Network Timing Protocol (NTP), and a Real-Time Protocol (RTP).

14. The CE router of claim 11, wherein the synchronization information comprises a plurality of packets transporting timing information, and wherein the controller is programmed to assign traffic priority to said plurality of packets.

15. In a customer premise equipment (CPE), a method comprising the steps of:
intercepting synchronization information from a PE router; and
synchronizing elements of the CPE according to the synchronization information.

16. The method of claim 15, wherein the synchronization information is derived from a CE router coupled between the CPE and the PE router, and wherein the PE router is coupled to a Building Integrated Timing Supply (BITS).

17. The method of claim 15, comprising the step of intercepting synchronization information according to a synchronization protocol comprising one among a Precision Time Protocol (PTP), a Network Timing Protocol (NTP), and a Real-Time Protocol (RTP).

18. A method, comprising the steps of:
receiving at a CE router synchronization information from a PE router; and
synchronizing the CE router according to the synchronization information.

19. The method of claim 18, comprising the steps of:
supplying customer premise equipment (CPE) the synchronization information from the CE router; and
synchronizing the CPE according to the synchronization information.

20. The method of claim 18, wherein the synchronization information comprises a plurality of packets transporting timing information, and wherein the method comprises the steps of:
assigning traffic priority to said plurality of packets; and
supplying synchronization information at predetermined intervals determined according to an estimated out-of-synchronization cycle.

21. The method of claim 18, wherein the PE router receives synchronization information from a Building Integrated Timing Supply (BITS), and wherein the method comprises the step of supplying synchronization to the CE router according to a Precision Time Protocol (PTP).

22. The method of claim 21, wherein PTP complies with an IEEE 1588 standard.
